(19) United States
(12) Patent Application Publication
(10) Pub. No.: US 2003/0001382 A1
(43) Pub. Date: Jan. 2, 2003

(54) Caution ESD label with double MAC address number label attachment

(76) Inventor: Miguel N. Bermudez, Hillsboro, OR (US)

Correspondence Address: Todd M. Becker, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/016,508

(22) Filed: Dec. 10, 2001

Related U.S. Application Data
(62) Division of application No. 09/895,426, filed on Jun. 28, 2001.

(51) Int. Cl. B42D 15/00

(52) U.S. Cl. 283/114

(57) ABSTRACT

An article of manufacture is disclosed which comprises a component container and a plurality of labels removably affixed to the component container and having printed thereon an identifier, wherein the identifier is electronically encoded in a component inside the component container and uniquely identifies the component. A method is also disclose which comprises determining a unique identifier electronically encoded on a component, printing the unique identifier on a plurality of labels, and affixing the plurality of labels to a component container into which the component is inserted.

### TECHNICAL FIELD

This disclosure relates generally to labeling systems, and in particular but not exclusively, relates to a system for accurately labeling components of a device.

### BACKGROUND

Most complex devices consist of a number of components and sub-components located within the device. In some cases, it is important to be able to uniquely identify one or more of the components within the device. For example, computers are often linked to each other by networks. To enable the network link, each computer has a network card that allows it to be hooked up to the network and allows it to communicate with other computers on the network. Within each network, each network card located inside the computer must have a unique identification number, so that messages routed or sent to a particular computer can be properly routed to the address, the address consisting of the unique identification number of the access card. If there is more than one access card with the same identification number in a network, it can lead to misrouted mail, confusion among users, or complete paralysis and shut down of the network.

Because of the importance of uniquely identifying the address of each network card, it is very important that the identification number for each network card be accurately entered by, for example, network administrators into a database such as a routing table that will then allow messages or other network traffic to be directed to the proper computer. At present, the unique identification number each access card is somehow printed on the outside of the device into which they are incorporated. Usually, when the network card is manufactured, a series of labels are printed out and inserted into the bag in which the network card is packed for shipment to the customer who then puts together the larger device. The labels are usually printed out in large numbers, and then simply dropped inside the shipping container in which the network cards are sent to the laptop manufacturers. This, of course, can lead to the wrong label being inserted into the bag with each network card, meaning that the wrong code numbers will end up in the databases and can lead to the network into which the network card is installed not working properly.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic drawing of an embodiment of a system and method for accurately labeling and identifying a component of a device

FIG. 2 is a view of an embodiment of labels produced by the system and method shown in FIG. 1.

FIG. 3 is a schematic of an embodiment of a use of the labels of FIG. 2 to identify a component of a laptop computer.

### DETAILED DESCRIPTION OF THE ILLUSTRATED EMBODIMENTS

Embodiments of an apparatus and method for accurately labeling components of a device are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

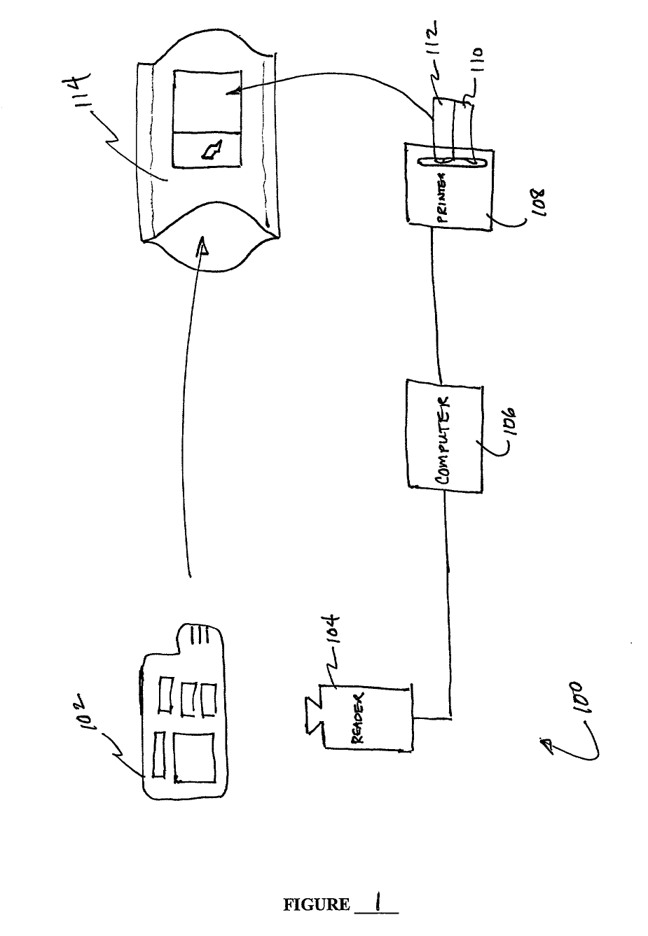

FIG. 1 illustrates an embodiment of a system 100 for accurately labeling a component such as a network card 102 that forms part of a device such as a laptop computer. Most computers include a network card 102 that allows them to connect to a network and communicate with other computers in the network. Each network card 102 in a network conforming to the IEEE 802 standard has an identifier known as a Media Access Control (MAC) address electronically encoded in its circuitry. The MAC address is a hardware address that uniquely identifies each node of a network. In any network, each network card 102 must have a unique MAC address, otherwise the network server will be unable to differentiate between the different computers hooked up to the network. In addition to each network card 102 having its own MAC address, each MAC address must be accurately recorded in databases, routing tables and the like; even if all the network cards 102 in a network have unique MAC addresses, duplicate MAC addresses in databases or routing tables can result in severe network problems.

The system 100 includes a reader 104 connected to, and in communication with, a computer 106. The computer 106 is in turn connected to, and in communication with, a printer 108 capable of printing labels, such as adhesive labels. The reader 104 is capable of reading the MAC address from the network card 102 and transmitting it to the computer 106. The computer 106 receives the MAC address input from the reader 104, and transmits it to the printer 108. The printer 108 in turn prints the MAC address of the network card 102 on a pair of labels 110 and 112. Although this embodiment of the system 100 is described in the context of a network card for laptop computer, the system 100 can be used for other components and devices as well, or in any situation in where labeling must accurately identify the contents of a container.

In operation, the network card 102 passes by and/or is inserted into the reader 104 so that the MAC address encoded therein can be read. Once the MAC address is read from the network card 102, the reader transmits the MAC address to the computer 106, which converts the MAC address into appropriate printer instructions and transmits those instructions to the printer 108. The printer prints a pair of labels 110 and 112, each bearing the MAC address of the network card 102. Once printed, the labels 110 and 112 are removed from the printer and affixed to a container, such as electrostatic discharge (ESD) bag 114, into which the network card 102 will be inserted for shipping, and from which the network card 102 will later be removed for installation in a computer. In one embodiment, the two labels 110 and 112 are removed from the printer 108 and affixed to an area of the electrostatic discharge (ESD) bag designated to receive the labels. In another embodiment, the MAC address labels 110 and 112 can be affixed to a base label already attached to the ESD bag, or can be an integral part of a base label (e.g., a warning label) that is run through the printer to print the MAC address labels. The labels 110 and 112 are affixed to the base label in an area of the base label designated to receive them.

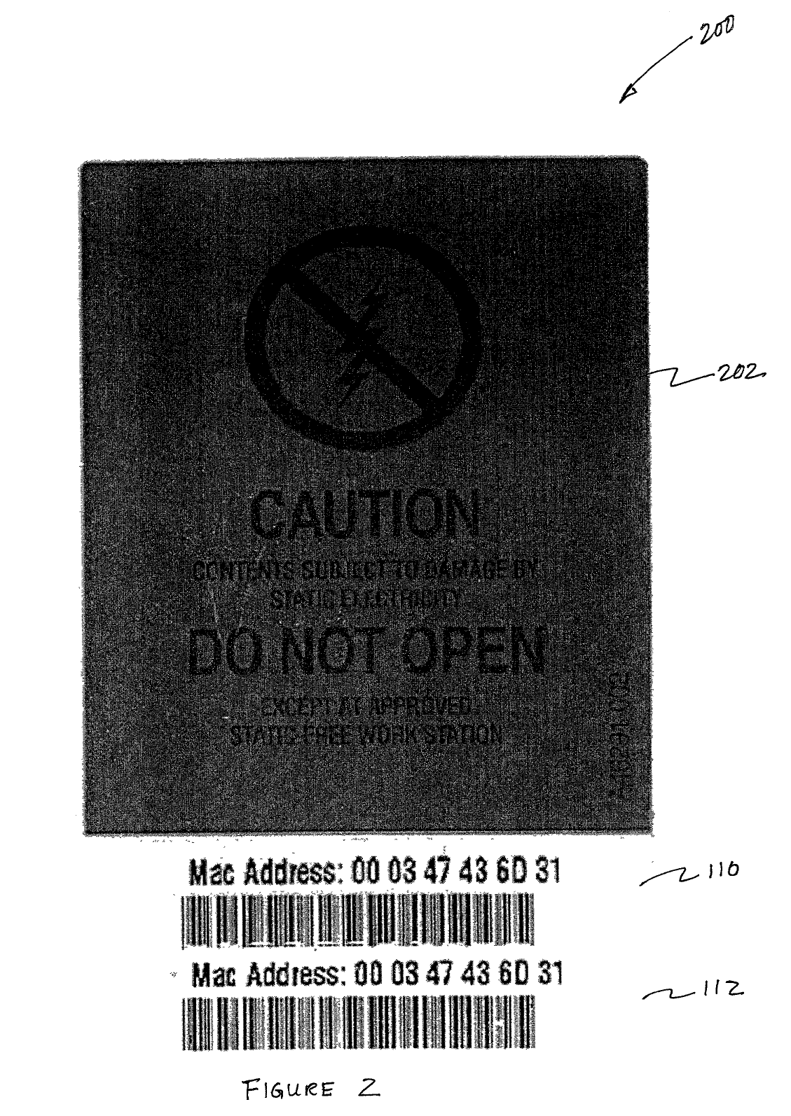

FIG. 2 illustrates an embodiment of a base label 200 that can be attached to the ESD bag 114. The base label 200 comprises an informational portion 202 and a portion comprising the two labels 110 and 112 that have the MAC address printed thereon. Both labels 110 and 112 are removably affixed to the base label 200 in a designated area below the informational portion 202. The exact appearance of the informational portion 202 and the labels 110 and 112 will depend upon the particular application to which the labels will be put. As shown, the informational portion 202 is an electrostatic discharge warning, and the labels 110 and 112 contain the MAC address of the network card 102 in Arabic numerals and a bar code, although the MAC address can also be printed on the labels in other forms, such as two-dimensional bar codes, alphanumeric codes, and the like. In other embodiments, the informational portion 202 can have some other warning or information printed thereon, and the labels 110 and 112 can have other identifiers printed thereon. In the embodiment shown, both labels 110 and 112 are identical, although in other embodiments they can be different. For example, the MAC address might be printed on one label in barcode only and on the other label in Arabic numerals only.

The labels 220, 110 and 112 can be made using paper, plastic, or any other material on which the MAC address can be printed. Preferably, they are made using a flexible fabric, such as polyester, so that they can easily conform to the changing shape of the underlying ESD bag 114 to which it is attached. This prevents detachment of the label from the bag. The base label 200 is preferably attached to the ESD bag 114 with adhesives pre-applied to the backsides of the base label, while the labels 110 and 112 are attached to the base label 200 with an adhesive that will allow the labels 110 and 112 to be removed from the ESD bag for later affixation elsewhere. Although two labels 110 and 112 are illustrated in this embodiment, in other embodiments more than two labels can be used, depending on the number of places the MAC address of the network card 102 must be accurately displayed.

The MAC address printed on each label 110 and 112 uniquely identifies and corresponds to the MAC address of the network card 102 stored on the inside of the ESD bag 114. By reading the MAC address directly from the network card 102, immediately printing the MAC address on the labels 110 and 112, and immediately placing those labels on the ESD bag 114, accurate identification of the network card 102 and display of its MAC address is assured. This represents an improvement over the prior art, in which large number of labels were printed out en masse, and then simply deposited on the inside of the ESD bag when the network card 102 was inserted therein. With the prior art, there is high potential for mixing up the labels, meaning that there is no assurance that the number on the label inserted in the bag will correspond to the MAC address of the network card 102.

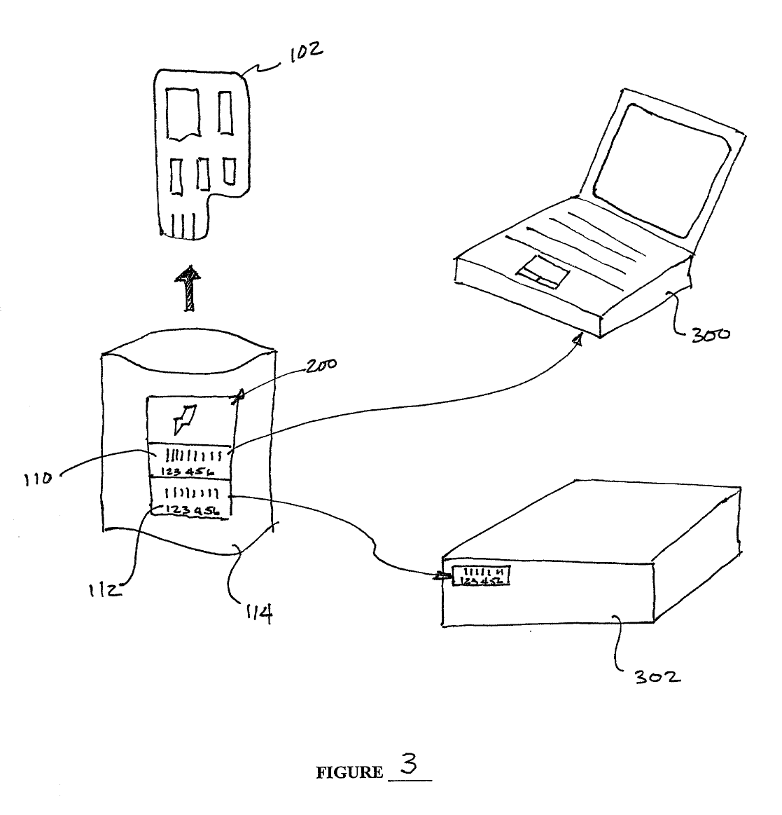

FIG. 3 illustrates use of the labels 110 and 112 upon their removal from the base label 200 on the ESD bag 114. When the manufacturer of a device such as laptop computer 300 receives the ESD bag 114 containing the network card 102, the network card 102 is removed from the ESD bag and installed in the proper slot in the interior of the laptop 300. As soon as the network card is installed on the laptop, the first label 110 is removed from the exterior of the ESD bag and pasted on the exterior of the laptop 300. By having a label on the exterior of the laptop, the MAC address of the network card contained therein can be easily determined without having to open up the laptop, remove the network card, and read the MAC address therefrom. The second label 112 is removed from the ESD bag 114 and is affixed to the exterior of the shipping container 302 in which the laptop 300 will be sent to the end user. By displaying the label 112 on the outside of the shipping container 302, the end user need not even open the shipping container to determine the MAC address of the network card inside the laptop. Instead, the end user can read the MAC number directly from the exterior of the packing container and enter it into the proper databases or routing tables, so that laptop 300 will function with the network once installed. This is of particular advantage to end users who buy large numbers of computers, because it would be a large burden to unpack every computer to determine its MAC address.

There are, of course, many other ways the labels 110 and 112 can be used. For example, the labels can be pasted or affixed in other locations. The general intent is to allow users to easily and accurately determine the MAC address of the network card inside the laptop without having to either unpack the laptop from its shipping container, or open up the laptop and extract the network card 102. As discussed above in connection with FIG. 2, there can also be more than two labels, depending on the number of places where it is necessary to display the MAC address of the network card 102 inside the laptop 300.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An article of manufacture comprising:
a component container; and
a plurality of labels removably affixed to the component container and having printed thereon an identifier, wherein the identifier is encoded in a component inside the component container and uniquely identifies the component.

2. The article of manufacture of claim 1 wherein the plurality of labels comprises a first label and a second label.

3. The article of manufacture of claim 2 wherein the first label is attached to a device in which the component is installed.

4. The article of manufacture of claim 2 wherein the second label is attached to a package in which the device is shipped.

5. The article of manufacture of claim 1 wherein the unique identifier is printed on the plurality of labels as a bar code.

6. The article of manufacture of claim 1 wherein the unique identifier of the component comprises an electronically encoded identifier.

7. The article of manufacture of claim 1 wherein the label is made of polyester.

8. The article of manufacture of claim 1 wherein the component container is an electrostatic discharge bag.

9. The article of manufacture of claim 1 wherein the plurality of labels are removably attached to the component container.

10. A method comprising:
determining a unique identifier encoded on a component;
printing the unique identifier on a plurality of labels; and
affixing the plurality of labels to a component container into which the component is inserted.

11. The method of claim 10 wherein the plurality of labels comprises a first label and a second label.

12. The method of claim 11, further comprising attaching the first label on a device in which the component is installed.

13. The method of claim 11, further comprising attaching the second label to a package in which the device is shipped.

14. The method of claim 10 wherein printing the unique identifier on the plurality of labels comprises printing a bar code on the labels.

15. The method of claim 10 wherein determining the unique identifier of the component comprises reading an electronically encoded identifier from the component.

16. The method of claim 10 wherein the label is made of polyester.

17. The method of claim 10 wherein the container is an electro-static discharge bag.

18. The method of claim 10 wherein the plurality of labels are removably attached to the component container.

19. An article of manufacture comprising:
a base label having a designated area thereon to receive an identification label;
a plurality of identification labels removably attached to the designated area of the base label, wherein the identification labels have printed thereon an identifier which uniquely identifies a component inside a component container to which the base label can be attached.

20. The article of manufacture of claim 19 wherein the plurality of identification labels comprises a first label and a second label.

21. The article of manufacture of claim 20 wherein the first label is attached to a device in which the component is installed.

22. The article of manufacture of claim 20 wherein the second label is attached to a package in which the device is shipped.

23. The article of manufacture of claim 19 wherein the unique identifier is printed on the plurality of identification labels as a bar code.

24. The article of manufacture of claim 19 wherein the unique identifier of the component comprises an electronically encoded identifier.

25. The article of manufacture of claim 19 wherein the base label and the plurality of identification labels are made of polyester.

26. The article of manufacture of claim 19 wherein the container is an electrostatic discharge bag.
